(19) United States
(12) Patent Application Publication
(10) Pub. No.: US 2024/0360306 A1
(43) Pub. Date: Oct. 31, 2024

(54) RAPID CURING EPOXY REPAIR COMPOSITION AND USE THEREOF

(71) Applicant: Illinois Tool Works Inc., Glenview, IL (US)

(72) Inventors: Duy Thach Tran, Glenview, IL (US); Rick Turpin, Glenview, IL (US); Timothy McKinney, Glenview, IL (US); Carlton Seaboldt, Glenview, IL (US); Grant Shouldice, Glenview, IL (US)

(73) Assignee: Illinois Tool Works Inc., Glenview, IL (US)

(21) Appl. No.: 18/609,351

(22) Filed: Mar. 19, 2024

Related U.S. Application Data
(60) Provisional application No. 63/462,280, filed on Apr. 27, 2023.

(51) Int. Cl. C08L 63/00; B63B 81/00; C08K 3/013; C08K 5/00; C09J 11/04; C09J 11/06; C09J 163/00

(52) U.S. Cl. CPC C08L 63/00; B63B 81/00; C08K 3/013; C08K 5/0025; C09J 11/04; C09J 11/06; C09J 163/00; C09J 2463/00

(57) ABSTRACT

A process for repairing a surface includes the mixing an epoxy resin formulation part A with a part B. The part A includes phenolic epoxy resin, polyol epoxy resin, or lipid epoxy resin, or a combination thereof. The part B includes a curing agent of only an aliphatic amine, a phenalkamine, a phenalkamide, or a combination thereof, to form a mixture. The mixture is applied to a substrate of the surface in need of repair to a thickness of up to 6.35 mm. The mixture cures on the substrate under conditions adapted to a dry to sand condition in 120 to 200 minutes. A process of operating a repaired marine substrate in a water contacting environment with limited water absorption is also provided. A composition for use in these processes is also provided.

### RELATED APPLICATIONS

The This application is a non-provisional application that claims priority benefit of U.S. Provisional Application Ser. No. 63/462,280 filed Apr. 27, 2023; the contents of which are hereby incorporated by reference.

### FIELD OF THE INVENTION

The present invention in general relates to a repair composition and in particular, an epoxy repair composition that provides improved cured mass properties in an exterior environment such as marine settings.

### BACKGROUND OF THE INVENTION

Fiberglass and metal marine hulls are susceptible to corrosion and other damage by way of collision, wave action, ice, or corrosion. Body fillers are used to repair such damage. Body fillers are known synonymously in the art as body putty.

Curing of thick marine fillers is a long process compared to a like thickness of an automotive filler. In some of the prior art, to cure thick marine fillers requires double the amount of time to achieve a sandable hardness relative to an automotive counterpart. Such marine fillers are exposed to greater operational forces than an automotive counterpart, especially when regions of repair are below the waterline. Attributes of water that include corrosiveness, impact forces, drag, and infiltration lead to marine filler compositions that favor cured composition properties relative to ease of use and differentiate these compositions from those used in the automotive setting.

As a result, many prior art marine fillers have a working time that is shorter than would otherwise be desirable. Furthermore, additional time is wasted in a repair waiting for complete cure as attempts to sand these before properly cured can ruin the attempted repair requiring additional effort.

Owing to the drag on marine surfaces below the waterline, high-quality surface finishes are required, such a surface layer is subjected to filling, sanding, trimming, and priming prior to receiving a paint coating that imparts a low drag and high gloss finish. Obtaining a smooth surface free of surface defects is important prior to painting, given that any surface defects present on the vehicle body surface tend to be amplified once paint is applied. A limiting factor in conventional application of epoxy-based body marine fillers is slow cure. The cure rates in conventional compositions cannot be further increased due to the fact that increasing the rate of the reactions would result further shortened working time. This is also manifest as a longer time until the cured mass is hard enough to be sandable to a feather edge.

Thus, there exists a need for an epoxy body filler composition that cures more rapidly than conventional compositions in exterior environments, such as a marine setting.

### SUMMARY OF THE INVENTION

A process for repairing a surface includes the mixing an epoxy resin formulation part A with a part B. The part A includes phenolic epoxy resin, polyol epoxy resin, or lipid epoxy resin, or a combination thereof. The part B includes a curing agent of only an aliphatic amine, a phenalkamine, a phenalkamide, or a combination thereof, to form a mixture. The mixture is applied to a substrate of the surface in need of repair to a thickness of up to 6.35 mm. The mixture cures on the substrate under conditions adapted to a dry to sand condition in 120 to 200 minutes.

A process of operating a repaired marine substrate in a water contacting environment includes curing a mass of an epoxy resin-having a thickness of up to 6.35 mm applied as a single layer to the substrate. The mass is then exposed to the water. The mass having a water absorption of 0.11% or less in ocean water salinity.

A composition including a part A and a part B. The part A includes phenolic epoxy resin, polyol epoxy resin, or lipid epoxy resin, or a combination thereof; a diluent; a corrosion inhibitor; and a filler. The part B includes a curing agent consisting essentially of an aliphatic amine, a phenalkamine, a phenalkamide, or a combination thereof; and an accelerator. The part B stored separately from the part A until mixed with the part A to form the composition.

### DETAILED DESCRIPTION OF THE PREFERRED EMBODIMENTS

The present invention has utility as an epoxy composition that cures rapidly compared to conventional compositions in marine applications, especially those for under the waterline applications. A method for curing highly filled, thick composite epoxy-based materials also have utility in marine repairs. To repair damage to marine vessels such as a boat, a personal watercraft, barge, ship or any form of commercial transport on water; a layer of epoxy filler is applied to the damaged area to a thickness of up to 250 mils (6.35 mm), cured, and shaped by sanding before applying subsequent layers. An inventive method results in curing of thick coatings of epoxy fillers with excellent properties for under the waterline repairs. This is carried out in a shorter cure time with better sandibility, longer working time, less water and saltwater absorption, and better corrosion resistance.

While the present invention is largely detailed with respect to marine repairs, it is appreciated that the present invention also finds application in the context it also has applications in the fields of aerospace, automotive repair, architectural structures, and industrial equipment repair. In aerospace, the invention is used during an initial assembly or a repair of an aerospace vehicle. The aerospace vehicle illustratively includes aircraft, spacecraft, missiles, bombs, rockets, drones, and components of any of the aforementioned. Such components illustratively include a frame, a skin, a flight control surface, a foil, a cowling, a blade, a fin, a wing, a tail, a landing gear, a fuselage, an aileron, a winglet, an elevator, a stabilizer, a rudder, a flap, an air brake, a slat, a spoiler, an aircraft canopy, a turbine, a door, a fuel tank, or a subassembly thereof. A subassembly illustratively includes an aileron, an air inlet, a boarding ladder, a bomb door, a bracket, a bulkhead, a control surface, a crew floor, a door, an elevator, an empennage, an engine cowl, an engine mount, an entry door, a fairing, a fin, a flap, a floor beam, a floor, a foil, a fuel cell, a fuel floor, a fuel tank, a fuselage, a gun door, a hinge, an instrument panel, a landing gear, a latch, a longeron, a nose, a nosecone, a pylon, a rib, a rudder, a skin, a spar, a spoiler, a stabilizer, a stringer, a tail, a thermal protector, a wheel well, a wing box, a wing, a winglet, or others.

The present invention also finds application in the context of architectural structures and used during an initial assembly or a repair of a building. The building illustratively includes a dwelling, a warehouse, a basement, a water or fuel tank, or a skyscraper.

An innovative feature that distinguishes current invention from prior art is the ability to cure masses with a thickness of up to 6.35 mm, and in 120 to 200 minutes; a shorter cure time compared to conventional products that at like thickness cure is more than 240 minutes. The inventive composition also has desirable properties relative to the prior art, with the properties so improved including resistance to sandability, water infiltration, saltwater absorption, corrosion resistance, and a combination of any of the aforementioned.

As will be detailed below, an exemplary inventive composition performs better than conventional epoxy marine filler products in the areas of water and saltwater absorption (50% less for water and 60% less for saltwater), corrosion resistance, cure time, working time for from 14 to 25 minutes, and sandability (50% better). An inventive composition when applied using conventional application methods has a cure time that is reduced by 20 to 50% from 240 min cure times of conventional products at a like thickness. An exemplary inventive composition also has a lengthened working time of the coating this is increased by up to 40% compared to conventional marine filler products, thereby providing additional time to correct deficiencies in the applied mass before the curing begins. In addition, the color change technology adds ease of use to the product with a visual change corresponding to the progress of the cure process until a dry to sand condition has been attained. As a result, an inventive composition saves time in performing marine repairs and the resulting repair is operative for a longer duration.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

As used herein, “sandable” with reference of a cured inventive formulation is defined as having limited clogging of sandpaper and able to form featheredge.

As used herein, “saltwater” as detailed herein for testing is defined as water having 3.5% salinity and a freezing point of −2° C.

As used herein, “freshwater” as detailed herein for testing is defined as deionized water having no salinity and a freezing point of 0° C.

While the present invention is detailed herein with respect to a 1:1 by volume ratio mixture of part A: part B, it is appreciated that other mix ratios are readily compounded ranging from 1:1±10% part A: part B without departing from the spirit of the present invention.

The present invention includes the modification of an epoxy resin composition to improve handling and cured mass properties in the context of marine and other settings. Substrates to which an inventive formulation are applied illustratively include fiberglass, mild steel, stainless steel, zinc/zinc-aluminum-coated steel, copper, bronze, silicon bronze, tin, aluminum, solder, brass, thermoplastics, and sheet molding compositions. The inventive formulation upon cure strongly adheres to the underlying substrate to which it is applied. Once cured and sanded, the inventive cured mass provides a surface prepared for and compatible with paint.

Using the method in the current invention results in curing of thick coatings of epoxy-based marine fairing compounds for below the waterline repairs. This is carried out in a shorter sand time, longer working time with better standability, less freshwater and saltwater absorption, and comparable corrosion resistance compared to the conventional epoxy-based marine fairing compound.

An inventive composition achieves the superior cure and physical properties through a selection of specific classes of epoxy resins and curing agents. Part A of an inventive formulation includes a phenolic epoxy resin, a polyol or lipid epoxy resin, or a combination thereof that are present in total in an amount of greater than 40 total percent by weight of part A. In some inventive embodiments the epoxy resins are present from 50 to 80 total weight percent of part A.

A phenolic epoxy resin suitable for use in the present invention illustratively include 2,2-bis(4-hydroxyphenyl)propane (bisphenol A), bis(4-hydroxyphenyl)methane (bisphenol F), novolacs formed by reacting formaldehyde with a phenol, and polyglycidyl ethers based on bisphenol A. These are commercially available under the tradenames EPON 825, EPON 826, EPON 828, EPON 1001, EPON 1007 and EPON 1009 from Hexion; DER 331, DER 332, DER 383, DER354, and DER 542 from The Dow Chemical Company; GY285 from Huntsman, Inc.; and BREN-S from Nippon Kayaku, Japan. The phenolic epoxy resin operative herein have an epoxy content of from 2 to 10 equivalents/mole. Exemplary phenolic epoxy resins operative herein have an epoxide equivalent weight of from 100 to 1000 grams/equivalent.

Polyol or lipid epoxy resins operative herein include glycerol glycidyl, lipid derived glycidyl ethers and saccharide-based glycidyl ethers having three or more epoxy functional groups. Examples of polymeric versions thereof illustratively include sorbitol polyglycidyl ether, isosorbide glycidyl ethers, pentaerythritol polyglycidyl ether, trimethylolethane triglycidyl ether, polyglycerol-3-glycidyl ether, castor oil triglycidyl ether; and a combination thereof. Examples of polyfunctional epoxy monomer versions thereof illustratively include diglycerol tetraglycidyl ether, dipentaerythritol tetraglycidyl ether, sorbitol polyglycidyl ether, polyglycerol polyglycidyl ether, and pentaerythritol polyglycidyl ether; hexafunctional glycidyl monomers, manatol polyglycidyl ether, sorbitol polyglycidyl ether (CAS 68412-01-1), and combinations thereof.

When both phenolic epoxy resin; and a polyol or lipid epoxy resin are both present, these are present in an epoxy equivalent ratio of between 0.5-1.5:1 of phenolic: polyol/lipid. Polymer epoxy resins used in an inventive composition have a weight average molecular weight ranging from 100 to 600,000, as determined by ASTM D4001-20. For purposes of calculating monomer percent, reactive diluents are omitted.

Additives are present in an inventive composition to improve at least one property of handling, storage, cure rate, sandability, or substrate adhesion. The additives illustratively include at least one of a thixotropic agent, a pigment, a filler, a leveling agent, or a wetting agent.

A thixotropic agent operative in the present invention illustratively includes fumed silica, organoclays, inorganic clays and precipitated silica. Multifunctional alcohols are commonly used to enhance thixotropic properties. A thixotropic agent is present from 0 to 10 percent by weight. The thixotropic agent is typically present from 0 to 2 total weight percent of a complete composition for application to a substrate.

A fast pigment or dye operative in the present invention illustratively includes titanium dioxide, carbon black, iron oxides, and phthalocyanine blue. These fast pigments and dyes are amenable to dissolution or suspension in the Part A and Part B. A pigment or dye is present from 0 to 10 total weight percent of a complete composition for application to a substrate. In some inventive embodiments, an unreactive pigment or dye, synonymously referred to herein as a fast pigment or dye is added to the part B to visually show a user when parts A and B have been uniformly mixed. For example, a white pigment, such as rutile, added to part A and a black pigment, such as iron oxide, added to part B will yield a uniform gray upon uniform mixing thereof.

Filler particulates or fibers operative in the present invention illustratively include talc, alumina trihydrate, calcium sulfate, calcium carbonate, magnesium sulfate, magnesium carbonate, barium sulfate, siloxane/silicone reaction products with silica, microspheres of glass or plastics, and the like. A filler is present from 0 to 49 total weight percent of a complete composition for application to a substrate. It is appreciated that a pigment and filler can have the same function and in those in stances where both are present in a composition, the amounts of both are cumulative.

A leveling agent operative in the present invention illustratively includes acrylic resins, fluorocarbons, fluoropolymers and silicones. A leveling agent is present from 0 to 2 total weight percent of a complete composition for application to a substrate.

A wetting agent operative in the present invention illustratively includes boric acid esters, phosphate esters, fatty acid salts, and polyethers. A wetting agent is present from 0 to 2 total weight percent of a complete composition for application to a substrate.

A corrosion inhibitor is added to limit substrate corrosion associated with water immersion in general, and saltwater in particular. Corrosion inhibitors operative herein include organically modified zinc aluminum molybdenum orthophosphate hydrate, zinc-5-nitroisophthalate, calcium borosilicate, a zinc salt of a benzoic acid, alkaline earth metal phosphate, zinc-barium phosphate, zinc phosphate, or combinations thereof. Zinc containing phosphates are noted to be particularly effective in the present invention. A corrosion inhibitor is present from 0 to 20 total weight percent of a complete composition for application to a substrate.

A resin composition is typically stored as a part A that includes all components with the exception of a curative package, and a part B containing a curative package that is mixed with the part A immediately before application to the marine substrate. An inventive composition is summarized in Table 1A.

To achieve the rapid cure and physical properties of the present invention, the aforementioned epoxy resins are cured with resort to a curing agent consisting essentially of an aliphatic amine, a phenalkamine, a phenalkamide, or a combination thereof. Curative package components are stored in part B and only combined with part A when cure initiation is desired. Curing agents operative therein illustratively include diethylenetriamine, triethylenetetramine tetraethylenepentamine diproprenediamine diethylaminopropylamine hexamethylenediamine, those detailed in WO2019185567, and combinations thereof. In some inventive embodiments, the curative package includes an aliphatic amine and at least of a phenalkamine, a phenalkamide, To achieve the properties of the present invention, it has been surprisingly found that aromatic amine, ketimine, secondary amines, tertiary amines, imidazoles, and mercaptans all fail to achieve the inventive cure rates, the physical properties of the resulting cured material, or both. The term consisting essentially of in the context of curing agents is defined herein as permitting these excluded curing agents to be present in trace amounts in an inventive formulation as these cannot be dominant curing agents to achieve the improvement of the present invention.

An epoxy hardener is used herein to achieve the rapid ready to sand properties and the resulting physical properties. Hardeners operative herein illustratively include poly(oxypropylene) diamine, nonylphenol, triethanolamine, polyoxyalkylencamines, piperazine, n-aminoethylpiperazine and combinations thereof. A hardener is present from 1 to 30 weight percent of part B.

The additives and fillers operative in part B are those detailed herein with respect to part A with the proviso that a cure suppressant is not present in part B.

Typical component amounts for an inventive product are provided in Tables 1A and 1B for parts A and B, respectively.

Tables 1A and 1B. Typical component amounts for resin side (part A) and hardener side (part B), where amounts are given in weight percentages unless otherwise noted:

TABLE 1A
Resin Composition (Part-A)

| | Typical | Preferred |
|---|---|---|
| Chemical | Weight % | Weight % |
| Curable Epoxies: | 40-90 | 50-80 |
| Phenolic Epoxy Resin | 20-60 | 22-40 |
| Polyol or lipid Epoxy | 20-60 | 25-45 |
| Resin | | |
| Diluent (e.g. styrene) | 0-10 | 0.2-5 |
| Thixotropic agent: organoclay | 0-4 | 1-3 |
| Wetting agent: alkylammonium | 0-4 | 0.5-2 |
| salt of an acidic copolymer | | |
| Adhesion Promoter | 0.1-2 | 0.2-1.5 |
| Corrosion inhibitor | 0-25 | 5-15 |
| Fillers/pigments: | Remainder | Remainder |
| | (<60% in total) | |
| | such as: | |
| Fast Pigment: TiO₂ | 0-6 | 0.3-5 |
| Siloxane/silicone reaction products | 0-15 | 1-5 |
| with silica | | |
| Microspheres | 0-15 | 6-9 |
| Talc: 0.5-20 micron | 0-40 | 5-20 |

TABLE 1B
Curative package (Part B)

| Chemical | Typical Weight % | Preferred Weight % |
|---|---|---|
| Curative Package: | 10-80 | 20-50 |
| Aliphatic amine | 0-40 | 30-60 |
| Phenalamine/phenalamide | 2-40 | 20-35 |
| Accelerator | 1-30 | 10-25 |
| Wetting agent: | 0-4 | 0.5-2 |
| alkylammonium salt of | | |
| an acidic copolymer | | |
| Corrosion inhibitor | 0-25 | 5-20 |
| Fillers/pigments/additives | Remainder such as: | Remainder |
| Pigment: black iron oxide | 0-6.0 | 0.3-5 |
| Siloxane/silicone | 0-40.0 | 1-5 |
| reaction products | | |
| with silica | | |
| Microspheres | 0-10.0 | 3-9 |
| Talc: 0.5-20 micron | 0-40.0 | 10-30 |

At dry to sand (“DTS”), the resulting mass has sufficient bond strength to the substrate to render a “featheredge,” meaning a smooth and gradual transition from primed areas to the edges primed areas, and no tearing or chipping at a perimeter edge of the cured mass on the substrate.

It is appreciated that because the cure of a given resin composition varies as a function of variables that illustratively include composition thickness, ambient air temperature, and cure temperature, the dye specifics as to amount and identity will have to be adjusted to coincide with the DTS condition as a function of variables such as those included in the non-exhaustive list above.

The present invention is further described with respect to the following non-limiting examples. These examples are intended to illustrate specific compositions according to the present invention and should not be construed as a limitation as to the scope of the present invention.

### Example 1

Table 1A and 1B preferred median component amount compositions are mixed by stirring the part A and the curative part B putty before usage. The part A specifically including epoxy resins of CAS 25085-99-8 (31 weight percent of part A) and 68412-01-1 (34 weight percent of part A), and styrene as the diluent, rutile as a white pigment, with 40 weight percent fillers than including talc (11 weight percent of part A), siloxane modified with silica (34 weight percent of part A) and glass microspheroids (7 weight percent of part A). The part B including aliphatic amine (21 weight percent of part B) and phenalamine (15 weight percent of part B), and nonylphenol as the accelerator (20 weight percent of part B), iron oxide as a black pigment, with 30 weight percent fillers than including talc (20 weight percent of part B), siloxane modified with silica (4 weight percent of part B) and glass microspheroids (6 weight percent of part B). The part B is hand mixed into part A at a volume ratio of 1:1 until a uniform gray color is achieved.

### Example 2

Table 2 shows a summary of testing results between a commercially available state of the art marine filler and an inventive marine repair composition of Example 1. Working time is checked by mixing each sample of marine fillers (part A) at 1:1 ratio by volume with part B. Then, applied to steel substrates at approximately 40 mil thickness. The materials are agitated everything 15 seconds to determine when the materials were no longer spreadable. Cure rate (Sand time) is checked by mixing each sample of marine fillers (part A) at 1:1 ratio by volume with part B. Then, applied to steel substrates at approximately 40 mil thickness. After working time, the sandability is checked every 30 seconds until minimum sandpaper clog is achieved. Freshwater and saltwater absorptions are conducted according to ASTM D570. Freshwater and saltwater (ASTM D1141-98) corrosion immersion testing is conducted at 93 degrees Fahrenheit for 500 hours.

Table 2 below shows a summary of testing results between a commercially available state of the art epoxy-based fairing compound and an inventive epoxy-based marine fairing compound.

TABLE 2
Comparison of properties between commercially available
epoxy-based fairing compound and that of Example 1.

| | | Dry to | Sandability | Fresh- | Salt- |
|---|---|---|---|---|---|
| | Working | Sand | Weight | water | water |
| | time | time | loss* | absorption | absorption |
| | (min) | (hours) | (wt. %) | (wt. %)** | (wt. %)** |
| Commercial | 13 | 4.5 | 2.30 | 0.32 | 0.29 |
| product | | | | | |
| Invention of | 18 | 2.5 | 3.42 | 0.17 | 0.11 |
| Example 1 | | | | | |
| % | ~40% | ~50% | ~50% | ~50% | ~60% |
| Improvement | Longer | Shorter | Better | Less | Less |

*measured per Evercoat SOP “ATP11” Sandibility
**measured per ASTM D570

As a person skilled in the art will recognize from the previous detailed description and from the figures and claims, modifications and changes can be made to preferred embodiments of the invention without departing from the scope of this invention defined in the following claims.

1. A process for repairing a surface comprising:
mixing an epoxy-resin formulation part A comprising: phenolic epoxy resin, polyol epoxy resin, or lipid epoxy resin, or a combination thereof; with a part B comprising: a curing agent consisting essentially of an aliphatic amine, a phenalkamine, a phenalkamide, or a combination thereof, to form a mixture;
applying said mixture to a substrate of the surface in need of repair to a thickness of up to 6.35 mm; and
curing said mixture on said substrate under conditions adapted to a dry to sand condition in 120 to 200 minutes.

2. The process of claim 1 further comprising a working time of 14 to 25 minutes prior to said curing occurring.

3. The process of claim 1 further comprising sanding said cured mixture to a feather edge.

4. The process of claim 3 wherein sanding occurs within 150 minutes of initiating said curing.

5. The process of claim 1 wherein the substrate is a marine hull or fairing.

6. A process of operating a repaired marine substrate in a water contacting environment comprising:
curing a mass of an epoxy resin-having a thickness of up to 6.35 mm applied as a single layer to the substrate;
exposing said mass to the water, said mass has a water absorption of 0.11% or less in ocean water salinity.

7. A composition comprising:
a part A comprising:
phenolic epoxy resin, polyol epoxy resin, or lipid epoxy resin, or a combination thereof;
diluent;
corrosion inhibitor; and
a filler;
a part B comprising: a curing agent consisting essentially of an aliphatic amine, a phenalkamine, a phenalkamide, or a combination thereof; an accelerator; said part B stored separately from said part A until mixed with said part A to form the composition.

8. The composition of claim 7 wherein said filler comprises at least one of calcium carbonate, microspheres, or talc.

9. The composition of claim 7 wherein said part A is mixed with said part B in a volume ratio of 1:1±10%.

10. The composition of claim 7 wherein said curing agent is said aliphatic amine, and at least one of said phenalkamine or said phenalkamide.
